(19) United States
(12) Patent Application Publication
(10) Pub. No.: US 2006/0140420 A1
(43) Pub. Date: Jun. 29, 2006

(54) Eye-based control of directed sound generation

(76) Inventor: Akihiro Machida, Sunnyvale, CA (US)

Correspondence Address: AVAGO TECHNOLOGIES, LTD., P.O. BOX 1920, DENVER, CO, 80201-1920, US

(21) Appl. No.: 11/022,115

(22) Filed: Dec. 23, 2004

(51) Int. Cl. H04R 3/00; H04R 1/02

(52) U.S. Cl. 381/116; 348/14.16; 381/387; 381/111

(57) ABSTRACT

In one aspect, an electronic system includes a source of an audio signal, a sound projector, an imaging system, and a controller. The sound projector is operable to generate at least one directed sound beam based on the audio signal. The imaging system is operable to capture images of a person in a space adjacent to the sound projector and to process images captured by the imaging system to identify at least one eye of the person and to estimate a position of the person in the space based on the identified ones of the person's eyes. The controller is operable to control the generation of the directed sound beam based on the estimated position of the person in the space.

### BACKGROUND

Many different types of sound-producing electronic systems have been developed, including radios, televisions, digital music players, digital video players, home theater systems, speaker phones, and portable electronic devices. The sounds produced by many electronic systems are non-directional (i.e., the sounds are radiated equally in essentially all directions). Some electronic systems, however, include sound systems that are capable of producing directed sound beams. In one approach, directed sound beams are produce by physically aiming one or more loudspeakers in a selected target direction. In another approach, directed sound beams are produce by a phased array of loudspeakers that are controlled to produce directed sound beams can be steered, focused, and shaped.

In one approach, a directed acoustic sound system includes a one-panel loudspeaker array that can deliver sound in up to seven separate beams that can be steered, as well as controlled to become a tightly focused or wider beam. Multi-channel surround sound can be delivered to a listener's position through reflections off ceiling and walls. The listener's position is determined based on signals transmitted to the system from a remote control unit that is carried by the listener.

In another approach, a directed acoustic sound system includes a disk-shaped parametric loudspeaker that may be mounted on a motorized mounting stand that can be rotated to different positions to account for varying listener positions. The mounting stand may be configured to track the listener automatically by sensing sounds produced by the listener's movements. The directed acoustic sound system also may include a proximity sensor (e.g., ultrasonic, echo, etc.) that detects how far the listener is from the system. The parameters of the loudspeaker may be optimally adjusted based on the detected proximity information.

An interactive directed light/light system has been proposed that includes a speaker system that can direct sound in a narrow beam. A motorized mount is used to redirect the sound beam to different locations. The system also includes a complex vision processing system that processes image data from one or more video cameras to distinguish moving (or “foreground”) objects from static (or “background”) parts of an interactive area. The vision processing system may be configured to track the location of each foreground object in the interactive area. The system stores information about the physical locations of real and virtual objects within the interactive area to allow users to interact with the virtual objects. In one implementation, a specialized audio stream is delivered to a single person moving around the interactive area. The specialized audio stream may be used to deliver music, private instructions, information, advertisements, or warnings to the person without disturbing others and without the encumbrance of headphones.

Hitherto, directed sound systems have either encumbered the listener with a locating device (e.g., a remote control) to determine the listener's location or have relied on locating methods that cannot readily distinguish persons from other objects without the use of substantial processing resources. In addition, none of the prior directed sounds systems is capable of controlling the generation of directed sound beams based on an unobtrusive detection of the listener's attentional state.

### SUMMARY

In one aspect, the invention features an electronic system that includes a source of an audio signal, a sound projector, an imaging system, and a controller. The sound projector is operable to generate at least one directed sound beam based on the audio signal. The imaging system is operable to capture images of a person in a space adjacent to the sound projector and to process images captured by the imaging system to identify at least one eye of the person and to estimate a position of the person in the space based on the identified ones of the person's eyes. The controller is operable to control the generation of the directed sound beam based on the estimated position of the person in the space.

In another aspect, the invention features a method of generating a directed sound beam. In accordance with this inventive method, images of a person in a space are captured. The captured images are processed to identify at least one eye of the person and to estimate a position of the person in the space based on the identified ones of the person's eyes. At least one directed sound beam is generated based on an audio signal and the estimated position of the person in the space.

Other features and advantages of the invention will become apparent from the following description, including the drawings and the claims.

### DESCRIPTION OF DRAWINGS

FIG. 1 is a diagrammatic view of an embodiment of an electronic entertainment system that includes at least one audio/video source, a receiver, a sound projector, a screen, and an imaging system.

FIG. 2 is a block diagram of the electronic entertainment system embodiment shown in FIG. 1.

FIG. 3 is a flow diagram of an embodiment of a method of generating a directed sound beam.

FIG. 4 is a diagrammatic top view of an implementation of the imaging system shown in FIG. 1 capturing images of a person.

FIG. 5A is a diagrammatic image of a person's eye that was illuminated with an on-axis light source.

FIG. 5B is a diagrammatic image of a person's eye that was illuminated with an off-axis light source.

FIG. 5C is a diagrammatic difference image resulting from the subtraction of the image of FIG. 5B from the image of FIG. 5A.

FIG. 6 is a diagrammatic view of an image of a person in a space adjacent to the sound projector shown in FIG. 1.

FIG. 7 is a flow diagram of an embodiment of a method of determining and responding to an attentional state of a person.

FIG. 8A is a flow diagram of an implementation of the method of FIG. 7.

FIG. 8B is a flow diagram of an implementation of the method of FIG. 7.

FIG. 9 is a diagrammatic view of the screen shown in FIG. 1 divided into three target screen regions.

FIGS. 10A-10C are diagrammatic images of a person's pupils corresponding to different orientations of the person's head with respect to the imaging system shown in FIG. 1.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

The embodiments that are described in detail below control the generation of directed sound beams in ways that readily distinguish persons from other objects without incorporating substantial processing resources and without encumbering the listener with a locating device (e.g., a remote control). In particular, these embodiments determine a listener's location based on image-based detection of a person's eyes. In addition, these embodiments also are capable of controlling the operational state of an electronic system, including controlling the generation of directed sound beams, based on an unobtrusive detection of the listener's attentional state.

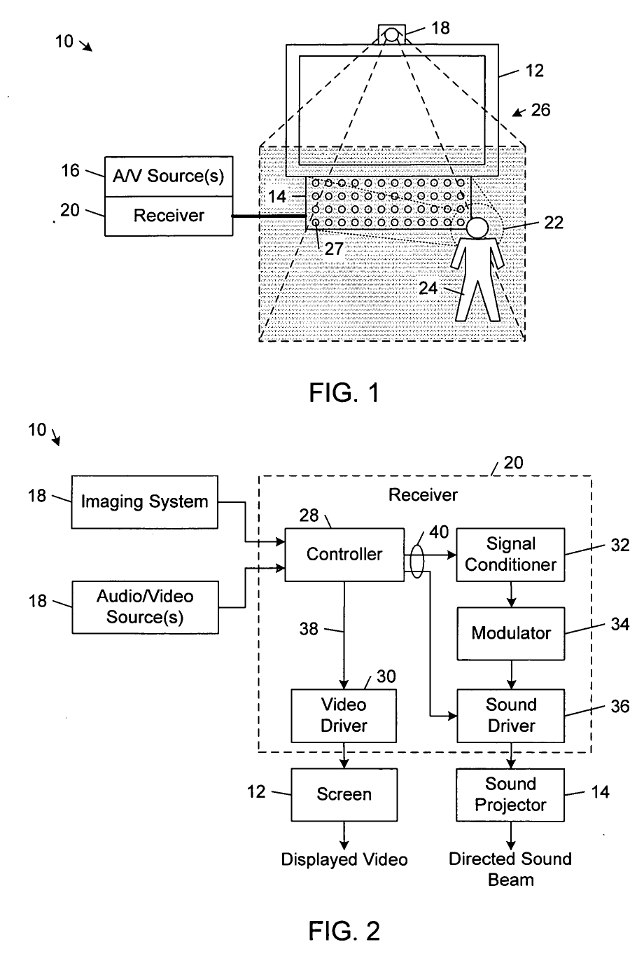

FIG. 1 shows an embodiment of an electronic entertainment system 10 that includes a screen 12, a sound projector 14, one or more A/V sources 16, an imaging system 18, and a receiver 20. The electronic entertainment system 10 is implemented in the form of a home theater system that may be installed in a person's home. The electronic entertainment system 10 is capable of displaying video and other images on the screen 12 and directing one or more sound beams 22 selectively to the location of a person 24 in a space 26 that is adjacent to the sound projector 14.

The screen 12 may be any type of video screen or monitor, including a CRT screen and a flat panel screen (e.g., a plasma display screen).

The sound projector 14 may be any type of sound system that is capable of selectively transmitting sound to particular locations in the space 26, including sound systems capable of physically aiming a loudspeaker to selected locations in the space 26 and sound systems capable of virtually aiming sound from an array of loudspeakers to particular locations in the space 26. In the implementation shown in FIG. 1, the sound projector 14 includes a two-dimensional array of transducers 27 whose phases can be adjusted to control where in the space 26 the sound waves that are produced by the transducers 27 cancel and sum. The phase of each frequency of sound is controlled independently so that the each sound frequency sums at the selected location in the space 26.

Each of the one or more A/V sources 16 may be any type of A/V source, including a CD player, a DVD player, a video player, an MP3 player, a broadcast radio, a satellite radio, an internet radio, a video game console, and a cable or satellite set-top box capable of decoding and playing paid audio and video programming.

The imaging system 18 includes an imaging device and an image processing system. The imaging device typically remains fixed in place in an orientation facing the space 26 in front of the sound projector 14. Exemplary imaging devices include remote-controllable digital cameras (e.g., a Kodak DCS760 camera), USB video cameras (or “webcams”), and Firewire/1394 cameras. In some implementations, the imaging device captures images at a rate of 30 fps (frames per second) and a resolution of 320 pixels×240 pixels. The image processing system controls the capture of images by the imaging device. As explained in detail below, the image processing system processes the captured images to identify at least one eye of the person 24 and estimates a position of the person in the space based on the identified ones of the person's eyes. In some implementations, the image processing system also processes the captured images to determine an attentional state of the person 24.

Referring to FIG. 2, in addition to common A/V receiver components, the receiver 20 includes a controller 28, a video driver 30, a signal conditioner 32, a modulator 34, and a sound driver 36. The controller 28 transmits video data and video control data to the video driver 30 along a video bus 38. The controller 28 also transmits audio data and audio control data along an audio bus 40. The signal conditioner 32 conditions the audio signals for each of the audio channels transmitted over the audio bus 40. The signal conditioner 32 performs standard audio production processes on the audio signals, including non-linear inversion, equalization, and compression. The modulator 34 modulates an ultrasonic carrier signal with the audio signal received from the signal conditioner 32 and transmits the modulated carrier signal to at least a subset of the transducers 27 of the sound projector 14. The sound driver 36 amplifies the modulated carrier signal. In addition, the sound driver 36 may apply a relative phase shift across all sound frequencies of the modulated carrier signal in order to steer, focus or shape the ultrasonic sound beam produced by the sound projector 14. The ultrasonic sound beam is demodulated into the audible, directed sound beam 22 as it passes through the air in the space 26. As explained in detail below, the controller 28 controls the signal conditioner 32 and the sound driver 36 to control the generation of the directed sound beam 22 based on the position of the person 24 in the space 26 that is estimated by the imaging system 18.

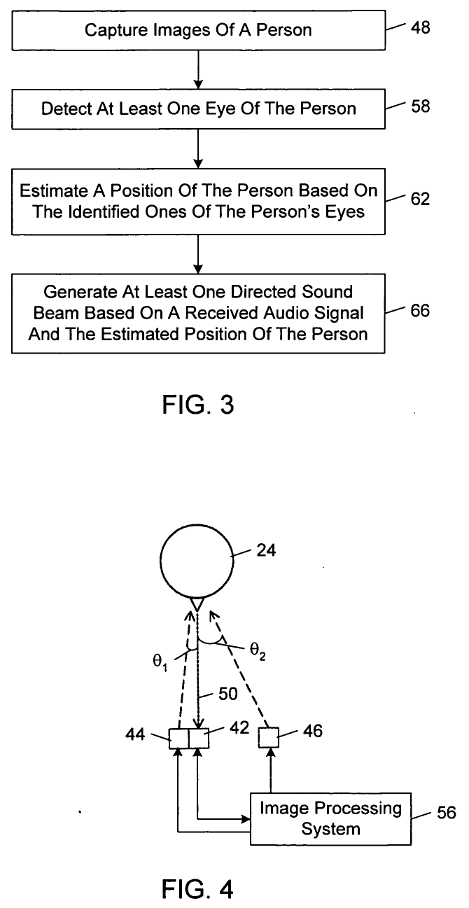

FIG. 3 shows an embodiment of a method by which the electronic entertainment system 10 controls the generation of the directed sound beam 22. Initially, the imaging system 18 captures images of the person 24 in the space 26 (block 48).

Referring to FIG. 4, in some implementations, the imaging system 18 includes an imaging device 42, an on-axis light source 44, and an off-axis light source 46. In some implementations, the imaging device 42 captures images of the person 24 in the space 26 at a rate of 30 fps and a resolution of 320 pixels×240 pixels. The on-axis light source 44 illuminates the person 24 with light directed along an angle θ₁ relative to the optical axis 50 of the imaging device 42, where θ₁ ranges from about 0° to about 2°. The off-axis light source 46 illuminates the person 24 with light directed along an angle θ₂ relative to the optical axis 50 of the imaging device 42, where θ₂ ranges from about 3° to about 15°.

In some implementations, the imaging device 42 captures the images of the person 24 alternately illuminated by the on-axis light source 44 and the off-axis light source 46. The light from the light sources 44, 46 are emitted in pulses that are synchronized with the frame rate of the imaging device 42. The light pulses may be emitted at a rate equal to the frame rate or in bursts each having a period longer than the frame rate. The wavelength of the light emitted from the light sources 44, 46 may be the same or different. In some implementations, the light emitted from both light sources is in the infrared or near-infrared wavelength ranges.

Differential reflectivity off the retinas of the person's eyes is dependent upon the angle θ₁ between light source 44 and the axis 50 of the imaging device 42, and the angle θ₂ between the light source 46 and the axis 50. In general, a smaller angle θ₁ will increase the retinal return (i.e., the intensity of light that is reflected off the back of the person's eye and detected by the imaging device 42). Accordingly, images captured with the person 24 illuminated by the on-axis light source 44 will contain a bright spot corresponding to the person's pupil when the person's eyes are open, whereas images captured with the person 24 illuminated by the off-axis light source 46 will not contain such a bright spot. Therefore, when the person's eyes are open, the difference between the images captured under the on-axis and off-acis illuminations will highlight the pupils of the person's eyes.

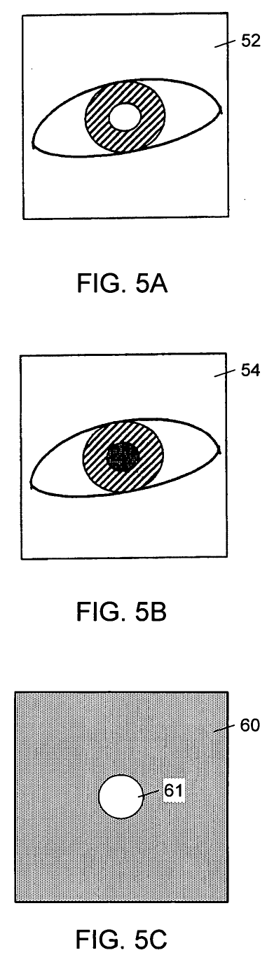

For example, FIG. 5A shows an exemplary image 52 of one of the person's eyes that was captured under the illumination of the on-axis light source. FIG. 5B shows an exemplary image 54 of the person's eye that was captured under the illumination of the off-axis light source 46. In the image 52, the area corresponding to the pupil region appears bright as a result of the specular reflection from the back of the person's eye. In the image 54, on the other hand, the pupil region appears dark. The intensities of the light sources 44, 46 are adjusted so that corresponding regions the images 52, 54 have substantially the same intensity levels.

In the illustrated embodiment, the imaging system 18 includes an image processing system 56 that processes the images captured by the imaging device 42 to detect at least one eye of the person 24 (block 58). In other embodiments, the image processing system 56 is incorporated in the receiver 20.

The image processing system 56 detects the person's eyes based on a difference image that is derived from the images that are alternately captured under the different illuminations that are provided by the on-axis and off-axis light sources 44, 46. An exemplary difference image 60, which corresponds to the subtraction of image 54 from the image 52, is shown in FIG. 5C. Under idealized conditions, all of the features in images 52 and 54 will cancel except for the pupil region, which will appear as a bright region 61 in the difference image 60. In some implementations, the image processing system 56 uses a thresholding process (e.g., an adaptive thresholding process) to distinguish pupil regions from the non-pupil regions in the difference image 60. The imaging processing system 56 identifies the person's eye based on the detection of a bright pupil region 61 in the difference image 60.

In general, the imaging device 42 and the light sources 46, 48 may be located at any distance from the person 24 within the space 26 so long as the light sources 46, 48 provide sufficient illumination for imaging device 42 to detect a retinal return along the optical axis 50. In addition, it is noted that this method of eye detection is substantially unaffected by the angle of the person's gaze toward the screen 12. Therefore, the orientation of the head and eyes of the person 24 may move relative to the light sources 44, 46 and the detector 42 without significantly affecting the efficiency and reliability of the eye detection process.

Additional details regarding the construction and operation of the above-described eye detection methods, as well as details regarding alternative methods of detecting the pupil regions of the person's eyes, may be obtained from U.S. Patent Application Publication No. 2004/0170304.

After the image processing system 56 has detected at least one eye of the person 24 (block 58), the image processing system 56 additionally processes the captured images to estimate the position of the person 24 in the space 26 based on the identified ones of the person's eyes (block 62). In some implementations, the image processing system 56 may map the position of the person's eyes in an image of the space 26 to a sound beam direction that can be used by the controller 28 to direct the sound beam 22 to the estimated location of the person 24.

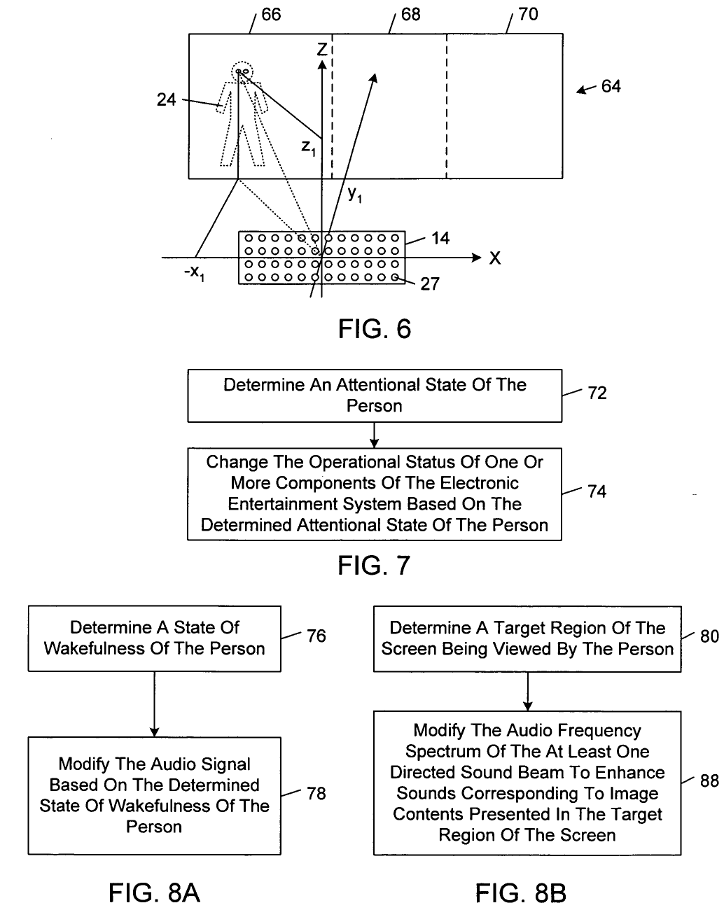

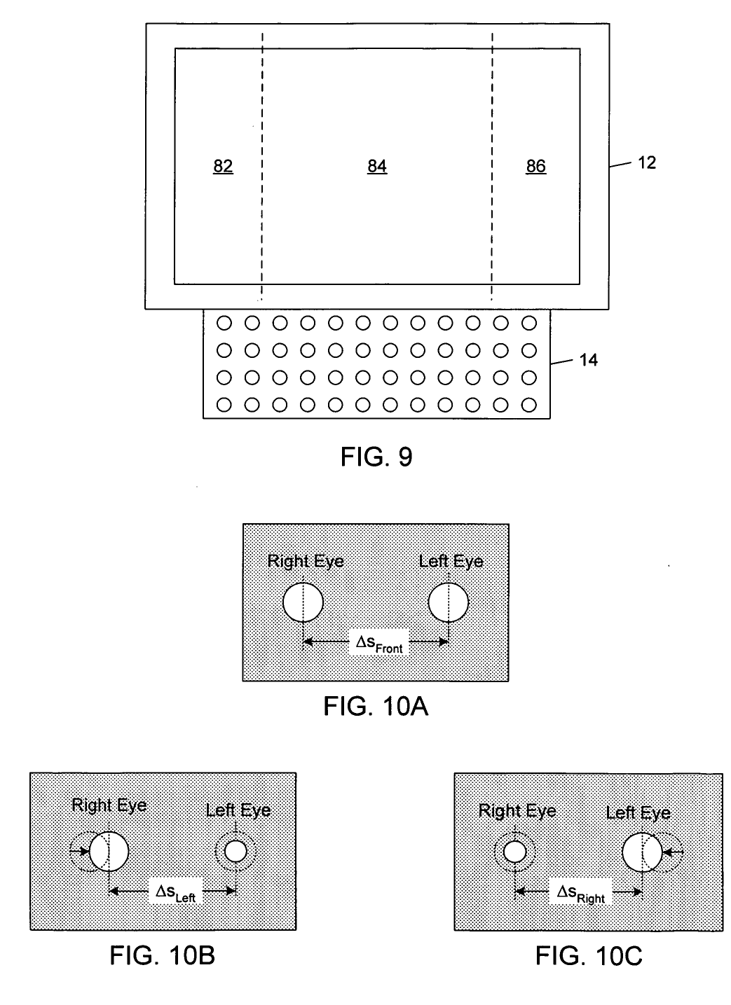

Referring to FIG. 6, in some implementations, the image processing system 56 determines the location of at least one of the person's eyes in an image 64 of the space 26 captured by the imaging device 42. In the illustrated embodiment, the location is determined in an X, Y, Z Cartesian coordinate system that is superimposed on the space 26 and centered at the center of the array of transducers 27 of the sound projector 14. The determined location of the person's eyes may correspond to the centroid of the identified eye locations. For example, in the illustrated embodiment, the centroid of the right eye of the person 24 corresponds to the coordinate (−x₁,z₁) in the image 64. The position of the person 24 may be estimated to be (−x₁,y₁,z₁), where y₁ is the distance of the person 24 from the sound projector 14 projected onto the Y-axis.

The distance y₁ may be determined by pre-calibrating the imaging system 18 with at least one predetermined listening locations (e.g., one or more predetermined seating locations in the space 26). For example, in one implementation, if the person's right eye appears in the left region 66 of the image 64, the distance y₁ is assumed to correspond to a calibrated distance D_{L}. If the person's eye appears in the center region 68 of the image 64, the distance y₁ is assumed to correspond to a calibrated distance D_{C}. If the person's eye appears in the center region 68 of the image 64, the distance y₁ is assumed to correspond to a calibrated distance D_{R}. Alternatively, the distance y₁ may be determined dynamically by using an optical (or acoustic) range finding device to determine the distance between the person 24 and the sound projector 14. The determined distance is mapped to the distance y₁ using simple geometry. Other methods of mapping the coordinates of the person's eye in the image 64 to a three-dimensional coordinate system that is anchored to the location of the sound projector 14 also may be used.

Referring back to FIG. 3, after the position of the person 24 in the space 26 has been identified by the image processing system 56 (block 62), the receiver 20 drives the sound projector 14 to generate at least one directed sound beam based on an audio signal received from the A/V sources 16 and the estimated position of the person 24 (block 66). The generated sound beam 22 may be focused onto a region in the space 26 that encompasses the head of the person 24. The sound focus region may be centered onto the estimated location of the person's eye or, if the locations of both eyes have been identified, the sound focus region may be centered onto the midpoint between the centroids of the two eye locations. In the illustrated implementation, the controller 28 controls the sound driver 36 to operate the transducers 27 of the sound projector 14 as a phased array by manipulating the phase relationships between the acoustic transducers 27 to obtain an interference in the ultrasonic field that causes the sounds to sum at the estimated location of the person 24 in the space 26. In other implementations, the controller 28 controls the sound driver 36 to steer the sound beam 22 in the direction of the estimated location of the person 24 in the space 26.

The size of the sound focus region may be determined empirically. In some implementations, the size of the sound focus region is selected to be large enough to encompass all of the eyes that are identified in the space 26, provided the size of the sound focus region does not exceed a predetermined threshold. In some of these implementations, if the sound focus region size that is needed to encompass all of the identified eyes would have to be larger than the predetermined threshold, multiple sound beams are generated and respectively focused onto respective clusters of ones of the eyes that have been identified in the space 26.

Referring to FIG. 7, in some implementations, the electronic entertainment system 10 may respond to an inferred attentional state of the person 24 as follows. During operation of the electronic entertainment system 10, the imaging system 18 determines an attentional state of the person (block 72). As used herein, the term “attentional state” refers broadly to the different modes in which the person 24 can apply his or her mind, including not at all (i.e., when the person 24 is asleep or unconscious), focused on the screen 12 or a particular region of the screen 12, focused somewhere other than the screen 12, or engaged in a specific activity (e.g., dancing).

In some these implementations, the imaging system 18 determines the attentional state of the person 24 based on the identification of the person's pupils in the images captured by the imaging device 42. For example, if the image processing system 56 fails to detect any eyes in the space 26 for longer than a prescribed period, the image processing system 56 may infer that nobody is located within the space 26 or that a person who previously entered the space 26 has either left the space 26, has fallen asleep, or is no longer interested in gazing at the screen 12. The image processing system 56 also may determine the focus of the user's attention based on an estimate of the angle of the person's gaze with respect to the entertainment system 10.

After the attentional state of the person 24 has been determined (block 72), the controller 28 may change the operational status of one or more components of the entertainment system 10 (block 74). The controller 28 may be programmed to respond the determined attentional state in many different, configurable ways. For example, the controller 28 may raise or lower the volume of the directed sound beam 22, change the equalization of the directed sound beam 22, change the images that are presented on the screen (e.g., present a predetermined visualization on the screen 12 when the person 24 is determined to be dancing to music), or selectively turn off or turn on one or more components of the entertainment system 10.

FIG. 8A shows a flow diagram of one implementation of the method of FIG. 7. In accordance with this implementation, the image processing system 56 determines a state of wakefulness of the person 24 (block 76). As mentioned above, the image processing system 56 may infer the state of wakefulness of the person 24 based on the detection of at least one of the person's eyes. The image processing system 56 may assume that the person 24 is awake unless pupils cannot be detected in the images captured by the imaging system 42 for more than a prescribed period of time (e.g., five minutes). Alternatively, the image processing system 56 may be configured to track the movement of the person 24 in the space 26. If the failure to detect the person's pupils is preceded by movement of the pupils across the space 26, the image processing system 56 may infer that the person has left the space 26 rather than infer that the person 24 has fallen asleep.

Depending on the determined state of wakefulness, the controller 28 may change the operational status of one or more components of the electronic entertainment system 10 (block 78). For example, if the person is determined to have fallen asleep, the controller 28 may lower the volume of the directed sound beam 22 or turn-down components of the electronic entertainment system 10 (e.g., place one or more components in a low-power standby mode of operation or a shutdown mode of operation). Alternatively, is the person is determined to have just woken-up, the controller 28 may increase the volume of the directed sound beam 22 or return the components of the electronic entertainment system 10 to their operational status before the person 24 fell asleep.

FIG. 8B shows a flow diagram of another implementation of the method of FIG. 7. In accordance with this implementation, the image processing system 56 determines a target region of the screen 12 being viewed by the person 24 (block 80). For example, in some implementations, the image processing system 56 may process the images captured by the imaging system 42 to determine whether the person's gaze is substantially fixed onto a left region 82 of the screen 12, a center region 84, of the screen 12, or a right region 86 of the screen 12.

In general, the angle of the person's gaze may be determined in any one of a wide variety of different ways. For example, known eye-gaze tracking systems, determine the person's gaze angle by tracking the relative positions of the glint and bright-eye reflections from at least one of the person's eyes when illuminated by infrared light.

Referring to FIGS. 10A-10C, in another eye-gaze tracking approach, the angle of the person's gaze also may be determined from changes in the relative sizes and spacing between the person's pupils, which may be detected using the method described above in connection with FIG. 4. Initially, the electronic entertainment system 10 may be calibrated by recording the relative size and spacing of the person's pupils when the person is located at a predetermined location in the space 26 and is facing the center region 84 of the screen 12 (FIG. 10A), gazing at the left region 82 of the screen 12 (FIG. 10B), and gazing at the right region 86 of the screen 12 (FIG. 10C). As shown in FIG. 10A, when the person 24 is facing the center region 84 of the screen 12, the detected pupils are about the same size and are spaced apart by a maximal amount (Δs_{Front}). When the person 24 is gazing at the left region 82 of the screen 12, the person's left eye appears smaller than the right eye and the spacing (Δs_{Left}) is less than the pupil spacing (Δs_{Front}) when the person is facing the center region 84. Conversely, when the person 24 is gazing at the right region 82 of the screen 12, the person's right eye appears smaller than the left eye and the spacing (Δs_{Right}) is less than the pupil spacing (Δs_{Front}) when the person is facing the center region 84. In this way, the image processing system 56 can infer the region of the screen 12 being viewed by the person 24 based on the relative sizes and spacing between the person's pupils.

Referring back to FIG. 8B, after the target region of the screen 12 being viewed by the person 24 has been determined by the image processing system 56 (block 80), the controller 28 may modify the audio frequency spectrum of the at least one directed sound beam 22 to enhance the sounds corresponding to the image contents being presented in the target region of the screen 12 (block 88). In this regard, the controller 28 may modify the equalization parameters used by the signal conditioner 32 to achieve the desired enhancement effect. In some implementations, the controller 28 may determine the audio frequency spectral components to be enhanced from the data encoded in the A/V signals received from the A/V sources 16. For example, several multimedia encoding protocols, such as Dolby digital 5.1, encode surround sound data that map audio content to multiple audio channels corresponding to different loudspeaker locations. In these encoding protocols, the audio content is synchronized with the video content that is displayed on the screen 12.

The controller 28 may use the encoded surround sound data to determine an appropriate modification of the equalization parameters. For example, if the person 24 is determined to be gazing at the right region 86 of the screen 12, the sounds in the right front and right rear channels of the encoded A/V signals might be enhanced; or the sounds in the center, left front and left rear channels might be reduced. If the person 24 is determined to be gazing at the left region 82 of the screen 12, the sounds in the left front and left rear channels of the encoded A/V signals might be enhanced; or the sounds in the center, right front and right rear channels might be reduced. If the person 24 is determined to be gazing at the center region 84 of the screen 12, the sounds in the center channel of the encoded A/V signals might be enhanced; or the sounds in the right front, right rear, left front and left rear channels might be reduced.

The systems and methods described herein are not limited to any particular hardware or software configuration. These systems and methods may be implemented in any computing or processing environment, including in digital electronic circuitry or in computer hardware, firmware, or software.

Other embodiments are within the scope of the claims.

For example, the embodiments were described above in the context of a home theater entertainment system. These embodiments, however, readily may be incorporated in a wide variety of other electronic systems, including broadcast, satellite and internet radio systems, television systems, memory-based video and music playback systems, and video game systems.

What is claimed is:

1. An electronic system, comprising:
a source of an audio signal;
a sound projector operable to generate at least one directed sound beam based on the audio signal;
an imaging system operable to capture images of a person in a space adjacent to the sound projector and to process images captured by the imaging system to identify at least one eye of the person and to estimate a position of the person in the space based on the identified ones of the person's eyes; and
a controller operable to control the generation of the directed sound beam based on the estimated position of the person in the space.

2. The system of claim 1, wherein the imaging system is operable to process images captured by the imaging system to determine an attentional state of the person.

3. The system of claim 2, wherein the controller is operable to modify the audio signal based on the determined attentional state of the person.

4. The system of claim 2, wherein the imaging system is operable to process images captured by the imaging system to determine a target of interest of the person, and the controller is operable to modify the audio signal based on received information relating to the determined target of interest.

5. The system of claim 2, further comprising a screen operable to display images, and wherein the imaging system is operable to determine a target region of the screen being viewed by the person.

6. The system of claim 5, wherein the controller is operable to modify audio contents of the at least one directed sound beam based on the determined target region of the screen.

7. The system of claim 6, wherein the controller is operable to modify the audio frequency spectrum of the at least one directed sound beam to enhance sounds corresponding to image contents presented in the target region of the screen.

8. The system of claim 2, wherein the imaging system is operable to determine a wakefulness state of the person, and the controller is operable to change the operational status of one or more components of the entertainment system including the sound projector based on the determined wakefulness state of the person.

9. The system of claim 1, wherein the controller is operable to steer the at least one detected sound beam to the estimated position of the person in the space.

10. The system of claim 1, wherein the imaging system is operable to determine a target region of the space containing detected eyes of one or more persons, and the controller is operable to focus the at least one directed sound beam onto the target region.

11. A method of generating a directed sound beam, comprising:
capturing images of a person in a space;
processing the captured images to identify at least one eye of the person and to estimate a position of the person in the space based on the identified ones of the person's eyes; and
generating at least one directed sound beam based on an audio signal and the estimated position of the person in the space.

12. The method of claim 11, further comprising processing the captured images to determine an attentional state of the person.

13. The method of claim 12, further comprising modifying the audio signal based on the determined attentional state of the person.

14. The method of claim 12, further comprising processing the captured images to determine a target of interest of the person, and modifying the audio signal based on the determined target of interest.

15. The method of claim 12, further comprising displaying images on a screen, and determining a target region of the screen being viewed by the person.

16. The method of claim 15, further comprising modifying audio contents of the at least one directed sound beam based on the determined target region of the screen.

17. The method of claim 16, further comprising modifying the audio frequency spectrum of the at least one directed sound beam to enhance sounds corresponding to image contents presented in the target region of the screen.

18. The method of claim 12, further comprising determining a wakefulness state of the person, and changing the operational status of one or more components of an entertainment system based on the determined wakefulness state of the person.

19. The method of claim 11, further comprising steering the at least one detected sound beam to the estimated position of the person in the space.

20. The method of claim 11, further comprising determining a target region of the space containing detected eyes of one or more persons, and focusing the at least one directed sound beam onto the target region.
